(19) United States
(12) Patent Application Publication
(10) Pub. No.: US 2016/0224762 A1
(43) Pub. Date: Aug. 4, 2016

(54) METHOD AND APPARATUS FOR PROMOTING MEDICATION ADHERENCE

(71) Applicant: Xerox Corporation, Norwalk, CT (US)

(72) Inventors: George A. Gibson, Fairport, NY (US); Karen M. Braun, Fairport, NY (US); Wendell L. Kibler, Rochester, NY (US)

(21) Appl. No.: 14/611,748

(22) Filed: Feb. 2, 2015

(51) Int. Cl. G06F 19/00

(52) U.S. Cl. CPC G06F 19/363; G06F 19/3456

(57) ABSTRACT

A method, non-transitory computer readable medium, and apparatus for promoting medication adherence are disclosed. For example, the method determines a barrier to an adherence to a prescribed medication for a patient, determines a reason for changing a behavior of the patient to bring about the adherence to the prescribed medication, receives a patient identified goal for implementing the changing of the behavior of the patient, and monitors whether the patient identified goal is met.

The present disclosure relates generally to providing information, and, more particularly, to a method and apparatus for promoting medication adherence.

### BACKGROUND

Patients who are suffering from various ailments are often prescribed medications to address the underlying diseases and/or to address physical symptoms caused by the underlying diseases. Although most patients are willing to adhere to the instructions (e.g., instructions pertaining to the taking of the medications as to the dosage and frequency) that are provided along with the prescribed medications, inevitably some patients are unwilling to adhere to the instructions. One example is the failure of a patient to finish the full course of a prescribed medication to treat a particular type of chronic illness or an illness that requires long term medication usage. For example, a normal course of treatment for tuberculosis (TB) may entail the taking of one or more antibiotics for a duration of 6 to 12 months. Since patients who are suffering from early stages of tuberculosis may not even exhibit any symptoms, the patients may erroneously believe such a long period of antibiotic treatment is unwarranted, unnecessary, too costly, and even possibly harmful to them. With such mindset, a patient may not adhere to the instructions prescribed by a doctor and prematurely end the taking of the required medication to treat a very serious disease. The consequences can be quite severe in that the disease is not properly treated for the patient and the premature ending of the treatment may potentially cause the disease to mutate into a more dangerous form where no treatment is even available. Thus, medication non-adherence has wide ranging consequences that extend beyond the individuals who are responsible for not adhering to the instructions of their doctors.

### SUMMARY

According to aspects illustrated herein, there are provided a method, a non-transitory computer readable medium, and an apparatus for promoting medication adherence. One disclosed feature of the embodiments is a method that determines a barrier to an adherence to a prescribed medication for a patient, determines a reason for changing a behavior of the patient to bring about the adherence to the prescribed medication, receives a patient identified goal for implementing the changing of the behavior of the patient, and monitors whether the patient identified goal is met.

Another disclosed feature of the embodiments is a non-transitory computer-readable medium having stored thereon a plurality of instructions, the plurality of instructions including instructions which, when executed by a processor, cause the processor to perform operations that determines a barrier to an adherence to a prescribed medication for a patient, determines a reason for changing a behavior of the patient to bring about the adherence to the prescribed medication, receives a patient identified goal for implementing the changing of the behavior of the patient, and monitors whether the patient identified goal is met.

Another disclosed feature of the embodiments is an apparatus comprising a processor and a computer readable medium storing a plurality of instructions which, when executed by the processor, cause the processor to perform operations that determines a barrier to an adherence to a prescribed medication for a patient, determines a reason for changing a behavior of the patient to bring about the adherence to the prescribed medication, receives a patient identified goal for implementing the changing of the behavior of the patient, and monitors whether the patient identified goal is met.

### BRIEF DESCRIPTION OF THE DRAWINGS

The teaching of the present disclosure can be readily understood by considering the following detailed description in conjunction with the accompanying drawings, in which:

FIG. 1 illustrates an example block diagram of a system of the present disclosure;

FIG. 2 illustrates an example flowchart of one embodiment of a method for promoting medication adherence; and

FIG. 3 illustrates a high-level block diagram of a computer suitable for use in performing the functions described herein.

To facilitate understanding, identical reference numerals have been used, where possible, to designate identical elements that are common to the figures.

### DETAILED DESCRIPTION

As discussed above, medication non-adherence has wide ranging consequences that extend beyond the individuals who are responsible for not adhering to the instructions of their doctors. One important aspect of addressing medication non-adherence is to first determine the underlying cause (broadly a perspective of the patient) for the medication non-adherence on an individual basis, i.e., understanding why an individual is not following the instructions associated with the prescribed medication. For example, the present method attempts to establish the patients' own perspective, i.e., patient identified barriers, as to why medication adherence was not achieved. Useful questions include (but not limited to):
1) “Are you convinced of the importance of your prescribed medication?”
2) “Do you believe that your prescribed medication will do more harm than good?”
3) “Do you have financial issue related to your prescribed medication?”

The patient's responses to the above questions may comprise (but not limited to):
1) “I am convinced of the importance of my prescribed medication.”
2) “However, I worry that my prescribed medication will do more harm than good to me.”
3) “Furthermore, I feel financially burdened by my out-of-pocket expenses for my prescribed medication.”

It should be noted that the above questions and responses are only illustrative. The important aspect is that through these illustrative questions/answers, the patient is providing the barrier(s) that is the underlying cause for medication non-adherence for this particular patient. For example, the underlying causes, barriers, or perspectives may encompass: 1) a failure to understand or trust in the importance, effectiveness and/or efficacy of the medication, 2) a belief that the medication may be harmful, and 3) the cost of the medication is not affordable. It should be noted that this list of underlying perspectives responsible for medication non-adherence is only illustrative and should not be deemed to be exhaustive.

However, although understanding the underlying cause(s) as to why an individual is failing to follow the instructions for a prescribed medication is important, that knowledge alone is insufficient to bring about a change in the behavior of the individual. For example, if a patient states that “I am not convinced that I need to take the antibiotics for the full 10 days, especially I felt great after taking the medication for 5 days,” then one can assume that this individual's barrier to medication adherence is related to a failure to trust in the importance of finishing the full course of the medication. One can certainly address this individual's barrier by demonstrating to the individual the importance of finishing the full course of the medication, e.g., via published literature on why it is important to finish the full course of the medication, governmental statistics or studies on why it is important to finish the full course of the medication, and so on.

Although such approaches would appear on its face to solve the detected barrier to medication adherence for this particular individual, it may actually be ineffective. The reason is that the proposed response is essentially a repudiation of the individual's perspective, i.e., the response amounts to saying “no, you are thinking about it in the wrong way, and you need to think about it this way instead, which is the proper way.” Such generic response does not in any way address the specific concern of the patient. In other words, the patient does not feel that his or her concerns are taken seriously, thereby providing no motivation for the patient to change his or her behavior to bring about medication adherence.

In contrast, in one embodiment of the present disclosure, the method attempts to establish the patients' own view of relevant issues and their internal motivations for seeking a change in their behavior. Useful questions include (but not limited to):
1) “What would you like to see different about your current situation?”
2) “What makes you think you need to adhere to the medication therapy you have been prescribed?”
3) “What will happen if you don't take your medicine as prescribed?”
4) “What will be different if you complete your medication therapy?”
5) “What would be the good things about changing your medication adherence behavior?”
6) “How can I help you get past some of the difficulties you are experiencing?”
7) “What would your life be like 3 years from now if you changed your medication adherence behavior?”
8) “Why do you think others are concerned about your medication adherence behavior?”
9) If you were to decide to change, what would you have to do to make this happen?”
10) “Suppose you don't change, what is the worst thing that might happen?”
11) “What is the best thing you could imagine that could result from changing?”

The purpose of such questions is to allow the establishment of the concrete barriers that the patient is experiencing and the elicitation of the internal reasons that the patient has for change. The responses to these or similar questions can then be collected and analyzed. It should be noted that in one embodiment predefined responses can be presented in a pull-down menu to assist the patient in providing the responses to various questions. Alternatively, in an alternate embodiment, a natural language interface or recognition system can be deployed to process natural language responses.

Once the barrier(s) to medication adherence for a particular individual is determined, the method then solicits the patient's own reasons for changing his or her behavior that would likely bring about medication adherence. For example, the present method may determine that the barrier to medication adherence for a patient is due to the fear that the medication may cause long term harm, e.g., a long term treatment for tuberculosis (TB). The method may then attempt to elicit the patient's reasons for change that may bring about medication adherence. The reason may comprise a desire to be rid of tuberculosis so that the patient would not be contagious to family members, such as children of the patient; a desire to join a profession where the presence of tuberculosis may prohibit entry to the profession, e.g., the armed forces or the medical profession; a desire to avoid a financial burden in the future if the tuberculosis creates a debilitating condition where the patient cannot work; and so on.

Finally, the method then attempts to elicit the patient's own goal(s) or objective(s) for implementing the change in his or her behavior that will bring about medication adherence. For example, the patient may opt: 1) to speak to a medical professional on a periodic basis to confirm that the patient is on track to complete the prescribed medication, 2) to be monitored or tracked (e.g., electronically via an endpoint device that monitors the taking of a medication on a daily basis, via interaction by a patient with a website to confirm the taking of the prescribed medication on a daily basis, via a pharmacy tracking system that the patient is refilling the prescribed medication on a periodic basis that is consistent with the prescribed treatment schedule, and so on), 3) to request an alternate acceptable treatment that the patient is willing to comply with, e.g., requesting the use of an alternate drug that has an accelerated treatment schedule, requesting the use of an alternate drug that is cheaper, and so on, and/or 4) to request a change in the start of the prescribed medication, e.g., changing the start date of the medication due to the patient's financial concerns, requesting a pause in taking the medication to obtain a mid-treatment test to be performed to determine whether continued treatment is still required, and so on. The main aspect of this step in the present method is that the goals are set by the patients themselves. The patient's proposed goals can be presented to a medical professional to determine their feasibility (in whole or in part) in view of the patient's current prescribed medical treatment. If the proposed goals cannot be accepted, the present method may present alternatives that can approximate the patient's goals while achieving medication adherence. The important aspect is not that the patient's proposed goals will actually bring about medication adherence, but that the patient is actively engaged in attempting to achieve medication adherence. Without such interest to participate by the patient, simply lecturing the patient to comply will not likely produce medication adherence. Taking the views of the patient into consideration and working with the proposed goals of the patient will likely produce a patient tailored treatment schedule or plan that will likely achieve medication adherence.

In one embodiment, the method then tracks the patient's progress in achieving the agreed upon goals set with the help of the patient's own input. The monitoring can be achieved via an electronic interaction as discussed above, e.g., self reporting using an endpoint device such as a smart phone with the appropriate software applications, or interaction with a website. This monitoring is responsive to the goals that the patient set for himself or herself. Any self-reporting techniques can be used and the patient's performance can be periodically compared to the goals and progress messages are presented to the patient based on the monitoring. Self-reporting measures can be electronically enabled in the form of reminders, reporting and graphics (with self directed targets) augmented by external assessments of medication adherence such as medication possession ratio (MPR) if such information is made available through a sponsoring agency such as a pharmacy or healthcare payer.

In those instances where self-set goals by the patients are not matched by performance, the present method can optionally generate a query to the patients, engaging them in another round of investigation and providing modified supports and educational materials. Such conditions may arise in some instances because of continued resistance, because of an initial lack of consumer self-insight or indeed because the present method may not have performed a completely correct mapping to the responses to the supplied supports.

In one embodiment, the method may optionally provide support documentations to the patient to encourage medication adherence at various point of the medical treatment. For example, the present method may provide statistics to the patient as to the success of other patients who have reached a particular treatment milestone. For example, upon completing four months of a prescribed medication, the patient can be presented with government statistics as to a patient's chance of completely defeating the disease having reached this milestone, if and only if the patient continues with the prescribed medication (broadly referred to as positive support documentation that highlights the benefit of continual medication adherence). In another example, upon completing four months of a prescribed medication, the patient can be presented with government statistics as to a patient's chance of a relapse when a patient stops taking the prescribed medication even though he or she has reached this milestone (broadly referred to as negative support documentation that highlights one or more consequences of medication non-adherence). The support documentations allow the patient to be updated with medical information that will encourage medication adherence and/or discourage medication non-adherence. The type of support documentation to be presented can be tailored to a patient's profile, i.e., whether a particular patient will be better motivated by positive support documentation or negative support documentation. The support documentations can be presented in any number of communications channel, e.g., via electronic communications such as email messages, text messages, enclosures attached to these electronic messages, postings on the patient's social page if permitted by the patient, or through traditional communications channel such as direct paper mailings such as paper reports, pamphlets, magazines, and the like.

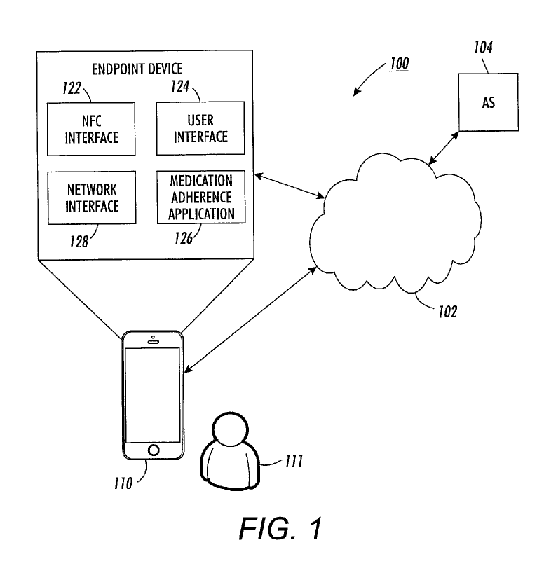

FIG. 1 illustrates an example system 100 of the present disclosure. The system 100 may include a network 102. In one embodiment, the network 102 may be a local network of a company or commercial enterprise. In another embodiment, the network 102 may be a network in the “cloud” or accessible over the Internet. In yet another example, network 102 may include a wireless access network, a mobile core network (e.g., a public land mobile network (PLMN)-universal mobile telecommunications system (UMTS)/General Packet Radio Service (GPRS) core network), and/or an Internet Protocol (IP) multimedia subsystem (IMS) network, and the like.

It should be noted that the network 102 is simplified for ease of explanation. The network 102 may include additional access networks or network elements (e.g., firewalls, border elements, gateways, application servers, and the like) that are not shown.

In one embodiment, a user or an individual (e.g., a patient) 111 is using an endpoint device, e.g., a mobile endpoint device 110. The user may be interested in using the services provided by an application server 104. In one embodiment, the application server 104 is a networked device that is capable of interacting with the network 102 over a wireless or wired connection. For example, application server 104 can be deployed with the method of the present disclosure as further discussed below.

In one embodiment, the endpoint device 110 may be any type of endpoint device (wired or wireless) that is used by a patient to access the services provided by the application server 104. The endpoint device 110 may include, for example, a mobile endpoint device (e.g., a smartphone, a cellular telephone, a laptop computer, a tablet computer, a watch, a pair of eye glasses and the like) or a wired endpoint device such as a desktop computer, a smart television and the like.

One embodiment of the present disclosure provides a system 100 where the endpoint device 110 is able to interact with the application server 104 to encourage medication adherence. In one embodiment, the endpoint device 110 comprises a wireless communication interface, e.g., a near field communication (NFC) interface 122, a user interface 124 (e.g., one or more displays), a medication adherence application or module 126, and a network interface 128 (e.g., one or more software applications such as browsers, interfaces and/or hardware components (e.g., transceivers) to interact with a network).

In one embodiment, the endpoint device 110 may initiate a connection with the application server 104. For example, the mobile endpoint device 110 may use network interface 128 to access one or more service features provided by the application server 104. In one embodiment, the application server 104 is operated by a doctor's office, a hospital, a medical insurance company, a pharmaceutical company, and/or a governmental agency that are interested in promoting medication adherence of patients. For example, the endpoint device 110 can be used by the user 111 to launch a medication adherence application 126 to provide various inputs to the application server 104 such as asking questions, answering questions, and providing patient goals as discussed above to promote medication adherence. In one embodiment, the medication adherence application 126 is an applet that can be downloaded from the application server 104 for the benefit of the user 111. The medication adherence application 126 may include features such as storing patient goals to achieve medication adherence, storing a schedule, e.g., a calendar, relating to the required prescribed medication that must be taken by the patient, tracking patient consumption of the prescribed medication in accordance with the schedule, and so on.

In one embodiment, the wireless communication interface, e.g., a near field communication (NFC) interface 122, can be used to interact with various tracking devices to confirm or ensure that the patient has taken the medication. For example, a pill bottle cap or a pill dispensing device may interact wirelessly with the wireless communication interface 122 to report each instance in which one or more pills were dispensed presumably to be taken by the patient. The reporting of this event can be monitored and tracked by the medication adherence application 126 of the endpoint device 110. In turn, the monitored activities or events associated with medication adherence can then be reported back to the application server 104, e.g., periodically in accordance with a predefined schedule or when polled by the application server 104. This allows the mobile device of the patient to be part of system that will encourage and monitor a patient's medication adherence. If the patient is detected to be failing to follow the prescribed instruction for a medication, the application server 104 with the assistance of the endpoint device 110 may provide a reminder that the patient has failed to adhere to the schedule prescribed for the medication. In addition to the reminder, the patient can be encouraged to reach out to a medical professional and/or the application server 104 to provide patient inputs as to why the patient has failed or is unwilling to adhere to the schedule prescribed for the medication. Such patient input when received in a timely manner, will allow server 104 to quickly deduce the cause of the medication non-adherence and to devise a possible remedy for the patient.

For example, the patient may provide patient input that indicates the patient is having financial trouble and has decided to temporarily stop taking the medication or to attempt to “stretch” the medication by skipping a few doses from time to time due to cost. Such behavior may bring about severe consequences to the patient or other individuals in the future. When such events are detected in a timely manner, the application server 104 may suggest alternative source of obtaining the medication at a lower cost, e.g., an online pharmacy company, a charity that may assist needy individuals in maintaining their medical treatments, an assistance program operated by the manufacturer of the medication who may be willing to provide medical loans or grants to needy individuals who are currently on the medication but are having financial difficulty in paying for the medication, and so on.

When the mobile endpoint device 110 connects to the application server 104 (either directly or via a communication network 102), the mobile endpoint device 110 may display a user interface (UI) 124 to the user. The UI may be a graphical user interface that includes inputs, commands or instructions that are associated with the application server 104. In one example, a list of questions can be presented on the user interface (UI) 124 to the user 111. The user interface (UI) 124 may also present a list of possible answers, e.g., in a pull down menu, that are correlated to the list of questions.

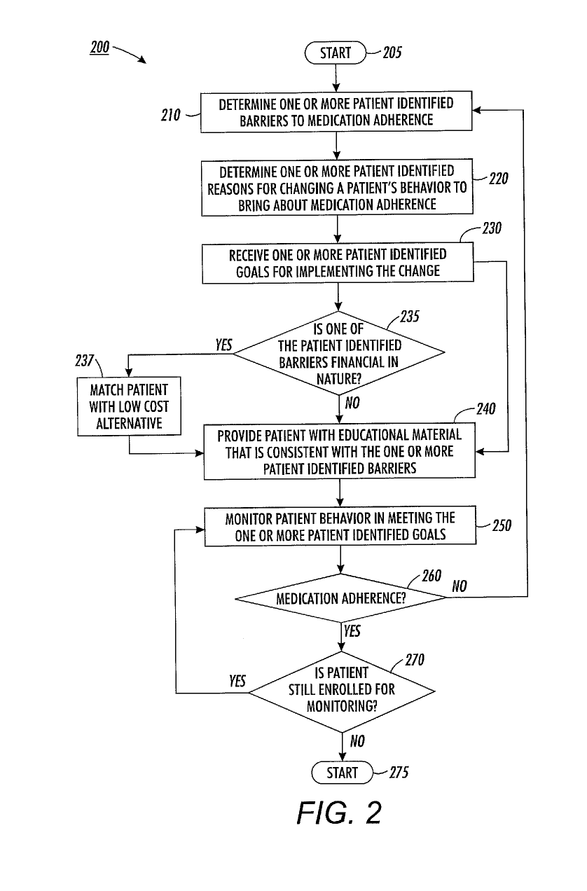

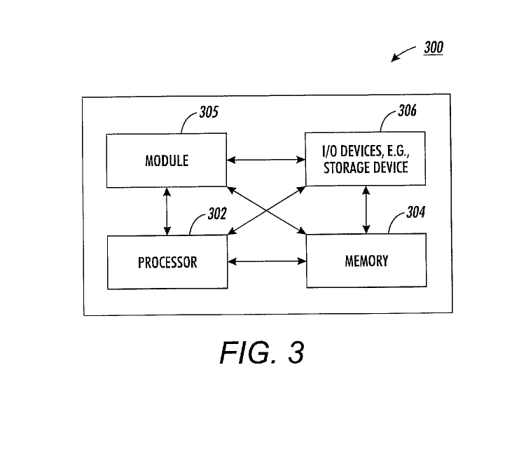

FIG. 2 illustrates an example flowchart of a method 200 for promoting medication adherence for a patient. In one embodiment, one or more steps or operations of the method 200 may be performed by the endpoint device 110 or a computer as illustrated in FIG. 3 and discussed below.

At step 205 the method 200 begins. At step 210, the method 200 determines one or more patient identified barriers to medication adherence for a patient. In one embodiment, the patient is presented with a series of questions as discussed above. For example, through the use of various questions presented to the patient, the method 200 is able to determine one or more barriers that are the underlying cause to medication non-adherence for this particular patient. For example, the underlying barriers may encompass one or more of: 1) a failure to understand or trust in the importance, effectiveness and/or efficacy of the medication, 2) a belief that the medication may be harmful, and/or 3) the cost of the medication is not affordable.

At step 220, the method 200 determines one or more patient identified reasons for changing a patient's behavior that will bring about medication adherence. Again, in one embodiment, the patient is presented with a series of questions as discussed above. For example, the underlying reasons may encompass one or more of: 1) protecting the patient's family members from an infectious disease, 2) joining a particular profession where the presence of the disease may be a barrier to entry to the profession, and/or 3) avoiding long term negative health effect resulting from the lingering disease, and so on. It should be noted that this list of reasons is only illustrative and not intended to be exhaustive. Again, the benefit of this operation is that the patient is actively participating in providing the underlying reason (broadly patient identified reason) for ensuring that the proposed change will likely be achieved.

In step 230, the method 200 receives one or more patient identified goals for implementing the change in the patient's behavior. For example, the goals may comprise one or more of: 1) agreeing to speak to a medical professional on a periodic basis, 2) agreeing to be monitored as to the taking of a medication, 3) agreeing to report any financial issues impacting medication adherence, and/or 4) agreeing to request a change in the timing of the prescribed medication if medication non-adherence is imminent, and so on. Again, this list of goals is only illustrative and not intended to be exhaustive. By encouraging the patients to formulate their own goals that are set by the patients themselves, there will be a greater chance that the patients will try to meet these patient identified goals.

In step 235, the method 200 determines whether one of the patient identified barriers is financial in nature. For example, a patient may simply stop taking the prescribed medication due to a sudden financial burden, e.g., losing a job, a sudden increase in the cost of the prescribed medication, taking on a new financial liability such as schooling cost for a child, and so on. If one of the identified barriers is financial in nature, then method 200 proceeds to step 237. If none of the identified barriers is financial in nature, then method 200 proceeds to step 240.

In step 237, the method 200 will attempt to match the patient with a low cost alternative to address the identified financial barrier. For example, the patient may be directed to an alternative source (e.g., an online vendor or institution) of obtaining the prescribed medication at a lower cost. In another example, the patient may qualify for an assistance program that is tailored to the patient's specific financial hardship, e.g., the loss of a job may qualify for a government sponsored or subsidized prescription drug program. In another example, the patient may be directed to a drug manufacturer that may have a subsidized prescription drug program for patients who can demonstrate financial hardship, e.g., obtaining the prescribed medication as a reduced cost and so on.

In step 240, the method 200 may optionally provide the patient with educational material that is consistent with or pertinent to the one or more patient identified barriers (e.g., via electronic interactions such as emails with enclosures of the educational material, text messages, and/or links to websites to allow the patient to download educational material). For example, if the patient identified barrier pertains to a concern as to the long term safety of taking a prescribed medication, then the educational material can be statistics or a report pertaining to the effect of the prescribed medication being taken over a long period of time. In another example, if the patient identified barrier pertains to a concern as to the efficacy of the prescribed medication, then the educational material can be statistics taken from clinical trials of the prescribed medication and so on. In another example, if the patient identified barrier pertains to a concern as to the affordability of the prescribed medication, then the educational material can be pricings extracted from various sources selling the prescribed medication, pricings of generic drugs corresponding to the prescribed medication, and/or availability of government subsidies for the prescribed medication (e.g., the federal government may have a strong interest for public safety in eradicating tuberculosis, thereby setting up subsidies to assist patients to pay for the prescribed medication and so on).

In step 250, the method 200 monitors the behavior of the patient to determine whether the patient identified goal(s) are being met. For example, the monitoring can be achieved via an electronic interaction as discussed above, e.g., self reporting using an endpoint device such as a smart phone with the appropriate software applications, or interaction with a website. This monitoring is responsive to the goals that the patient set for himself or herself in step 230. Any self-reporting techniques can be used and the patient's performance can be periodically compared to the goals and progress messages are presented to the patient based on the monitoring.

In step 260, the method 200 determines whether medication adherence is achieved for the patient. For example, if the patient's treatment is scheduled for a period of six (6) months, then at the end of 6 months, the method 200 determines whether the patient has taken the amount of prescribed medication as instructed over the six month period, e.g., via records obtained from a pharmacy, via electronic interactions with the patient, via records obtained from a government entity providing subsidies for the prescribed medication, and so on. Any methods of determining medication adherence can be used. If medication adherence is not achieved, then method 200 proceeds back to step 210 to repeat some or all of the earlier described steps. It could be that the patient was not entirely honest in answering the earlier presented questions and/or the goals set by the patient were not realistic or practical. In any event, the method 200 (or only one or more steps of method 200) can be repeated any number of times to fine tune the goals set by the patient to bring about medication adherence. In other words, additional or different barriers, additional or different reasons for change, and/or additional or different goals can be determined for the patient.

If medication adherence is achieved, then method 200 proceeds to step 270. In one embodiment, method 200 may optionally provide a congratulatory message to the patient informing the patient that the goals set by the patient have brought about medication adherence. Such positive re-enforcement may have lasting effect for the patient who may have to face yet another round of medical treatment in the future. In turn, the present automated system and method will be positively viewed by the patients as a useful tool that the patients can dynamically access in the future to address any medication adherence issues. Furthermore, in step 270 method 200 determines whether the patient is still enrolled for monitoring. For example, the patient may have a chronic disease where long term treatment may be required either periodically or continually (e.g., severe infections associated with coccidioidomycosis (Valley Fever), Wilson disease, HIV infections, and so on), or where a patient is monitored for a potential relapse (e.g., psychiatric illnesses, substance abuse problems, and so on). Under these scenarios, some patients may be enrolled in a monitoring program that extends beyond a single instance or time period of medication adherence. As such, method 200 may optionally determine whether a patient is still enrolled for monitoring for medication adherence. If the answer is positive, then the method 200 returns to step 250. If the answer is negative, then the method 200 ends in step 275.

It should be noted that although not explicitly specified, one or more steps, functions, or operations of the method 200 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 2 that recite a determining operation, or involve a decision, do not necessarily require that both branches of the determining operation be practiced. In other words, one of the branches of the determining operation can be deemed as an optional step. In addition, it should be noted that FIG. 2 in some embodiments may be performed using any combination of the steps (e.g., using fewer than all of the steps) illustrated in FIG. 2 or in an order that varies from the order of the steps illustrated in FIG. 2.

It should be noted that the present method improves the field of medication adherence. Specifically, in one embodiment, the patient is encouraged to participate in formulating one or more goals to bring about medication adherence. In one embodiment, the present method utilizes a hardware system to automate the process of interacting with the patient through a series of questions to uncover the underlying barrier(s) or cause(s) of the patient's inability to meet medication adherence. Furthermore, the present method is able to transform responses and inputs provided by the patient into a concrete medication adherence plan to bring about medication adherence.

FIG. 3 depicts a high-level block diagram of a computer suitable for use in performing the functions described herein. As depicted in FIG. 3, the system 300 comprises one or more hardware processor elements 302 (e.g., a central processing unit (CPU), a microprocessor, or a multi-core processor), a memory 304, e.g., random access memory (RAM) and/or read only memory (ROM), a module 305 for promoting medication adherence, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements. Furthermore, although only one computer is shown in the figure, if the method(s) as discussed above is implemented in a distributed or parallel manner for a particular illustrative example, i.e., the steps of the above method(s) or the entire method(s) are implemented across multiple or parallel computers, then the computer of this figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 305 for promoting medication adherence (e.g., a software program comprising computer-executable instructions) can be loaded into memory 304 and executed by hardware processor element 302 to implement the steps, functions or operations as discussed above in connection with the exemplary method 200. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for promoting medication adherence (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method, comprising:
determining, by a processor, a barrier to an adherence to a prescribed medication for a patient;
determining, by the processor, a reason for changing a behavior of the patient to bring about the adherence to the prescribed medication;
receiving, by the processor, a patient identified goal for implementing the changing of the behavior of the patient; and
monitoring, by the processor, whether the patient identified goal is met.

2. The method of claim 1, wherein the determining the barrier to the adherence to the prescribed medication comprises presenting a list of questions to the patient and analyzing one or more responses received from the patient.

3. The method of claim 1, wherein the determining the reason for changing the behavior of the patient to bring about the adherence to the prescribed medication comprises presenting a list of questions to the patient and analyzing one or more responses received from the patient.

4. The method of claim 1, further comprising:
determining, by the processor, the barrier is a financial barrier; and
providing, by the processor, a low cost alternative to address the financial barrier.

5. The method of claim 1, further comprising:
providing, by the processor, an educational material to the patient that is related to the barrier.

6. The method of claim 1, further comprising:
determining, by the processor, the adherence to the prescribed medication by the patient is not met when the patient identified goal is not met.

7. The method of claim 6, further comprising:
performing, by the processor, at least one of: determining a second barrier to the adherence to the prescribed medication, determining a second reason for changing the behavior of the patient to bring about the adherence to the prescribed medication, and receiving a second patient identified goal for implementing the changing of the behavior of the patient.

8. The method of claim 1, further comprising:
determining, by the processor, the adherence to the prescribed medication by the patient is met when the patient identified goal is met.

9. The method of claim 8, further comprising:
sending, by the processor, a congratulatory message to the patient.

10. A non-transitory computer-readable medium storing a plurality of instructions which, when executed by a processor, cause the processor to perform operations, the operations comprising:
determining a barrier to an adherence to a prescribed medication for a patient;
determining a reason for changing a behavior of the patient to bring about the adherence to the prescribed medication;
receiving a patient identified goal for implementing the changing of the behavior of the patient; and
monitoring whether the patient identified goal is met.

11. The non-transitory computer-readable medium of claim 10, wherein the determining the barrier to the adherence to the prescribed medication comprises presenting a list of questions to the patient and analyzing one or more responses received from the patient.

12. The non-transitory computer-readable medium of claim 10, wherein the determining the reason for changing the behavior of the patient to bring about the adherence to the prescribed medication comprises presenting a list of questions to the patient and analyzing one or more responses received from the patient.

13. The non-transitory computer-readable medium of claim 10, further comprising:
determining the barrier is a financial barrier; and
providing a low cost alternative to address the financial barrier.

14. The non-transitory computer-readable medium of claim 10, further comprising:
providing an educational material to the patient that is related to the barrier.

15. The non-transitory computer-readable medium of claim 10, further comprising:
determining the adherence to the prescribed medication by the patient is not met when the patient identified goal is not met.

16. The non-transitory computer-readable medium of claim 15, further comprising:
performing at least one of: determining a second barrier to the adherence to the prescribed medication, determining a second reason for changing the behavior of the patient to bring about the adherence to the prescribed medication, and receiving a second patient identified goal for implementing the changing of the behavior of the patient.

17. The non-transitory computer-readable medium of claim 10, further comprising:
determining the adherence to the prescribed medication by the patient is met when the patient identified goal is met.

18. The non-transitory computer-readable medium of claim 17, further comprising:
sending a congratulatory message to the patient.

19. A method, comprising:
determining, by a processor, a barrier to an adherence to a prescribed medication for a patient, wherein the determining the barrier to the adherence to the prescribed medication comprises presenting a list of questions to the patient and analyzing one or more responses received from the patient;
determining, by the processor, a reason for changing a behavior of the patient to bring about the adherence to the prescribed medication;
determining, by the processor, the barrier is a financial barrier;
providing, by the processor, a low cost alternative to address the financial barrier;
receiving, by the processor, a patient identified goal for implementing the changing of the behavior of the patient;
providing, by the processor, an educational material to the patient that is related to the barrier;
monitoring, by the processor, whether the patient identified goal is met;
determining, by the processor, the adherence to the prescribed medication by the patient is not met when the patient identified goal is not met; and
performing, by the processor, at least one of: determining a second barrier to the adherence to the prescribed medication, determining a second reason for changing the behavior of the patient to bring about the adherence to the prescribed medication, and receiving a second patient identified goal for implementing the changing of the behavior of the patient.

20. The method of claim 19, wherein the determining the reason for changing the behavior of the patient to bring about the adherence to the prescribed medication comprises presenting a list of questions to the patient and analyzing one or more responses received from the patient.
